(19) United States
(12) Patent Application Publication
(10) Pub. No.: US 2010/0141079 A1
(43) Pub. Date: Jun. 10, 2010

(54) ELECTRIC MOTOR

(76) Inventors: Jun Jie CHU, Hong Kong (CN); Hui Fang Yu, Shenzhen (CN)

Correspondence Address: Muncy, Geissler, Olds & Lowe, PLLC, 4000 Legato Road, Suite 310, FAIRFAX, VA, 22033, US

(21) Appl. No.: 12/631,683

(22) Filed: Dec. 4, 2009

(30) Foreign Application Priority Data
Dec. 5, 2008 (CN) 200810218101.0

(51) Int. Cl. H02K 3/34

(52) U.S. Cl. 310/215

(57) ABSTRACT

An electric motor comprising a stator and a rotor, the stator comprising: a stator core having a yoke and a plurality of teeth extending inwardly from the yoke, a slot being formed between adjacent teeth; windings wound around the teeth; and a dielectric slot liner disposed between the stator core and the windings in each slot for insulating the stator core from the windings. Each slot liner comprises a body conforming the stator core in the slot and two ends each with a lip structure protruding relative to the body in a radial direction of the stator to increase the creepage distance between the winding and a distal end of a corresponding tooth of the stator core.

### CROSS REFERENCE TO RELATED APPLICATIONS

This non-provisional patent application claims priority under 35 U.S.C. § 119(a) from Patent Application No. 200810218101.0 filed in The People's Republic of China on Dec. 5, 2008.

### FIELD OF THE INVENTION

This invention relates to an electric motor and in particular, to an electric motor having slot liners.

### BACKGROUND OF THE INVENTION

FIGS. 1 & 2 show a known three-phase brushless direct current (BLDC) motor having a stator and a rotor. The stator 12 of the motor comprises stator core 13, windings 20 and a dielectric frame 27. The stator core 13 comprises teeth 14 on which the windings 20 are wound. Slots 23 are formed between adjacent teeth 14. The rotor 16 of the motor comprises magnetic poles 18 formed by magnets attached at the surface of a rotor core 17. Each winding coil 22 wound on a corresponding tooth 14 has one terminal A, B or C and another terminal X, Y or Z connected to a common node 25. A dielectric slot liner 28 is installed in each slot 23 between the winding coil 22 and the corresponding tooth 14.

Different electric motor applications powered by different voltages have different slot insulation requirements between the windings and the teeth. Usually, a creepage distance between the windings and the stator pole is adopted as a sign parameter for electric insulation property. Electric motors for low voltage use have relatively low slot insulation requirement and therefore a short creepage distance. Electric motors designed for use with high voltage have a relatively high slot insulation requirement and therefore a large creepage distance.

FIG. 3A shows a known slot insulation arrangement in which slot insulation paper 24 is installed between the tooth 14 (pole) of the stator core and the coil 22 and the slot 23 is relatively highly filled by the coil. This kind of slot insulation arrangement forms a short creepage distance between the stator core and the windings and therefore is only suitable for use as a low voltage electric motor.

FIG. 3B shows another known slot insulation arrangement in which slot insulation paper 24 is installed between a tooth of the stator core and coil of a high voltage motor. The coil 22 is shaped so that a relatively large distance remains between the distal end of the slot insulation paper 24 and the winding to increase the creepage distance between the stator core and coil. However, this solution reduces the fullness of the slot (known as the slot fill rate).

FIG. 3C shows a further known slot insulation arrangement in which slot insulation paper 24 is installed between a tooth of the stator core and coil 22 and includes an insulation plate 26 covering two facing ends of the slot insulation paper 24 in the slot to increase the creepage distance between the stator core and coil. This solution suits a high voltage motor but has the drawback of being difficult to assemble and has a low production efficiency.

### SUMMARY OF THE INVENTION

Hence there is a desire for an electric motor with an improved slot liner.

Accordingly, in one aspect thereof, the present invention provides an electric motor comprising: a stator and a rotor disposed in the stator, the stator comprising: a stator core having a yoke and a plurality of teeth extending inwardly from the yoke, a slot being formed between each pair of adjacent teeth; windings wound around the teeth; and a dielectric slot liner disposed between the stator core and the windings in each slot for insulating the stator core from the windings; wherein each slot liner comprises a body conforming to the stator core in the slot and two ends each with a lip structure protruding relative to the body in a radial direction of the stator to increase the creepage distance between the winding and a distal end of a corresponding tooth of the stator core.

Preferably, an opening is formed between distal ends of adjacent teeth and communicates with the corresponding slot, and a gap is formed between the lip structures of the slot liner corresponding to the opening.

Preferably, the width of the gap is less than or equal to the width of the corresponding opening.

Preferably, the lip structure protrudes inwardly relative to the body in the radial direction of the stator.

Alternatively, the lip structure protrudes outwardly relative to the body in the radial direction of the stator.

Alternatively, the lip structure protrudes inwardly and outwardly relative to the body in the radial direction of the stator.

Preferably, the slot liner is made of a dielectric material containing 70 percent plastic and 30 percent fiber glass by weight.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labelled with a same reference numeral in all the figures in which they appear. Dimensions of components and features shown in the figures are generally chosen for convenience and clarity of presentation and are not necessarily shown to scale. The figures are listed below.

FIG. 1 is a diagram of a known three-phase BLDC motor;

FIG. 2 is an isometric view of a part of the stator of the motor of FIG. 1;

FIGS. 3A to 3C show three known slot insulation arrangements for an electric motor;

FIG. 4 is a cross sectional view of a stator in accordance with a preferred embodiment of the present invention;

FIG. 5 is an enlarged view of a portion of FIG. 4;

FIG. 6 is an isometric view of the slot insulation liner of FIG. 4; and

FIG. 7 is a cross sectional view of an electric motor incorporating the stator of FIG. 4.

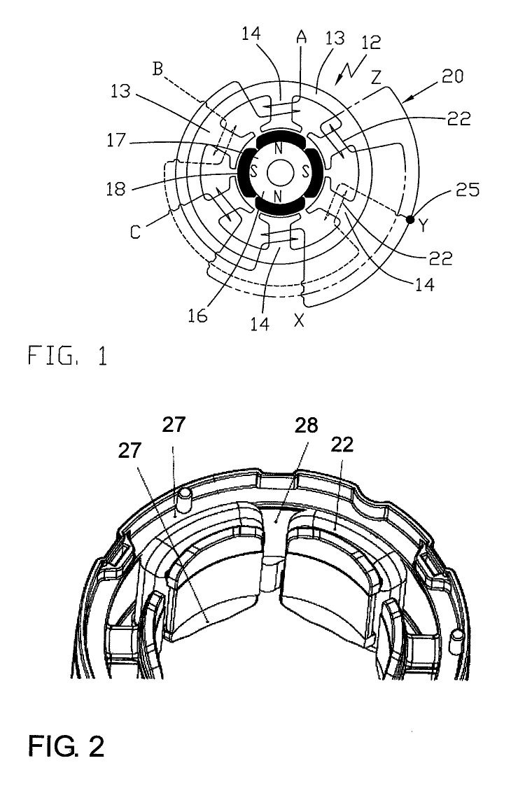

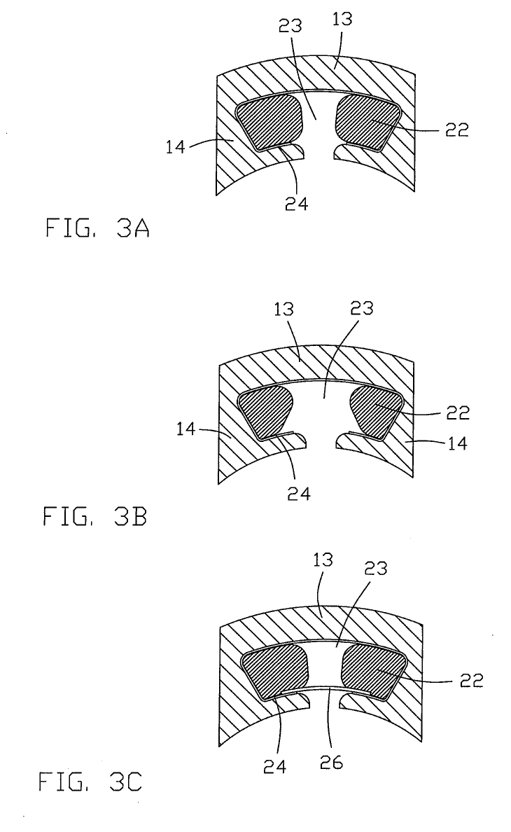

### DETAILED DESCRIPTION OF THE PREFERRED EMBODIMENT

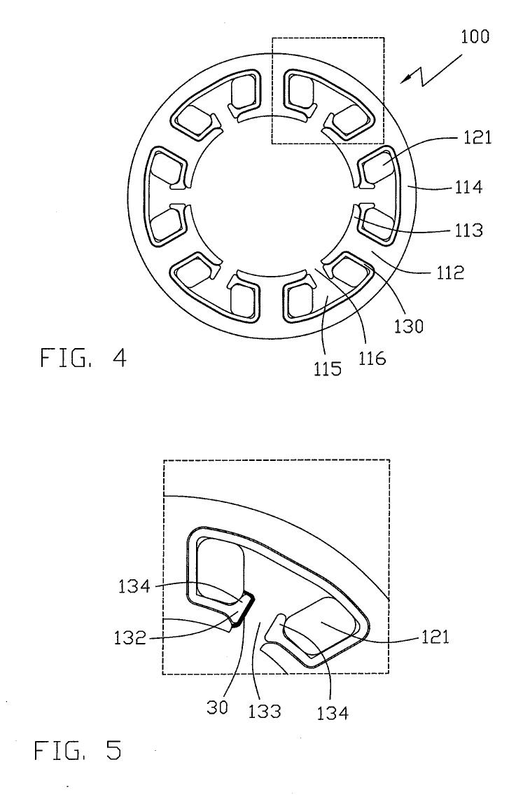

Referring to FIG. 4, a stator 100 of an electric motor in accordance with an embodiment of the present invention comprises a stator core and stator windings wound on the stator core. The stator core comprises a cylindrical yoke 114 and a plurality of teeth 112 extending inwardly from the yoke 114 in radial directions with even intervals in the circumferential direction. Each tooth 112 has a shoe 113 formed at a distal end thereof. A slot 115 is formed between each pair of adjacent teeth 112 and an opening 116 is formed between adjacent shoes 113 of the teeth 112 and communicates with the corresponding slot 115. Coils 121 forming the stator windings are wound on the teeth 112 and received in the slots 115. Prior to winding the coils 121, dielectric slot liners 130 are placed in each slot 115.

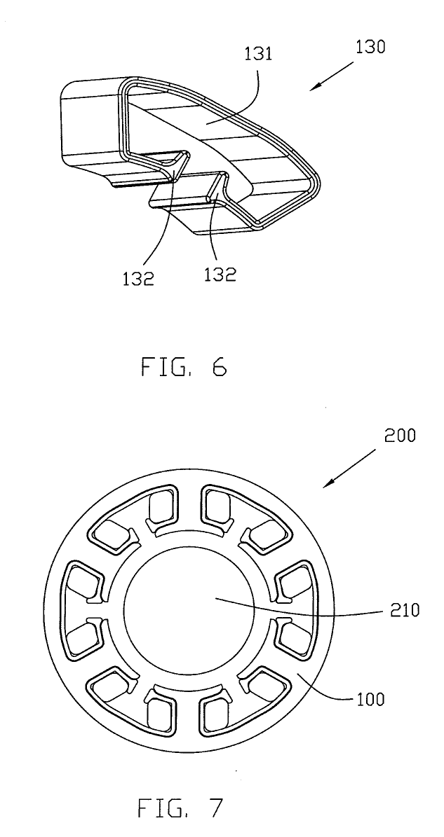

Referring to FIGS. 5-6, the slot liners 130 extend in the axial direction of the stator and the axial ends thereof extend beyond the corresponding axial end of the stator. Each slot liner 130 has a body 131 and two distal ends 132. The body 131 with uniform thickness matches/conforms with the surface of the slot 115 and contacts the surface of the stator core surrounding the slot 115. A gap 133 is formed between the two ends 132, corresponding to the opening 116 of the stator core to allow the winding 121 to enter the corresponding slot 115. Each end 132 has a lip structure 134, the direction of the lip structure 134 relative to the body 131 being perpendicular to the axial direction of the stator, preferably protruding in the radial direction. The gap 133 is defined between the two lip structures 134. Preferably, the width of the gap 133 is not greater than that of the corresponding opening 116 between the distal ends of adjacent teeth.

As shown in FIG. 5, the lip structure 134 is capable of increasing the creepage distance 30 between the coil 121 and the stator core. The above described stator is suitable for small size high voltage brushless direct current motor for driving a pump.

FIG. 7 shows a BLDC motor 200 having a permanent magnet rotor 210 disposed in the stator 100 of FIG. 4.

The slot liner 130 may be made of any suitable dielectric material, for example, a dielectric material containing 70 percent plastic and 30 percent fiber glass by weight.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. An electric motor comprising:
a stator and a rotor disposed in the stator, the stator comprising:
a stator core having a yoke and a plurality of teeth extending inwardly from the yoke, a slot being formed between each pair of adjacent teeth;
windings wound around the teeth; and
a dielectric slot liner disposed between the stator core and the windings in each slot for insulating the stator core from the windings;
wherein each slot liner comprises a body conforming to the stator core in the slot and two ends each with a lip structure protruding relative to the body in a radial direction of the stator to increase the creepage distance between the winding and a distal end of a corresponding tooth of the stator core.

2. The motor of claim 1, wherein an opening is formed between distal ends of adjacent teeth and communicates with the corresponding slot, and a gap is formed between the lip structures of the slot liner corresponding to the opening.

3. The motor of claim 2, wherein the width of the gap is less than or equal to the width of the corresponding opening.

4. The motor of claim 2, wherein the lip structure protrudes inwardly relative to the body in the radial direction of the stator.

5. The motor of claim 2, wherein the lip structure protrudes outwardly relative to the body in the radial direction of the stator.

6. The motor of claim 2, wherein the lip structure protrudes inwardly and outwardly relative to the body in the radial direction of the stator.

7. The motor of claim 1, wherein the slot liner is made of a dielectric material containing 70 percent plastic and 30 percent fiber glass by weight.
